(19) United States
(12) Patent Application Publication
(10) Pub. No.: US 2004/0113511 A1
(43) Pub. Date: Jun. 17, 2004

(54) Component for the rotor or stator of an electrical machine

(76) Inventors: Ralf Schmidt, Renchen (DE); Markus Heidrich, Buehl (DE)

Correspondence Address: Striker Striker & Stenby, 103 East Neck Road, Huntington, NY, 11743, US

(21) Appl. No.: 10/221,463

(22) PCT Filed: Nov. 29, 2001
(86) PCT No.: PCT/DE01/04475

(30) Foreign Application Priority Data
Jan. 18, 2001 (DE) 10102011.2
Feb. 14, 2001 (DE) 10106717.8

(51) Int. Cl. H02K 1/18; H02K 1/28

(52) U.S. Cl. 310/218

(57) ABSTRACT

Structural elements according to the related art are composed of a carrying body in the case of which it is expensive to arrange a winding, and the filling between the poles is not optimal.

A structural element (1) according to the invention comprises at least two carrying bodies (3, 5) having poles (11), in the case of which the distance between the directly adjacent poles (11) of the individual carrying body (3, 5) is so great that the winding method or the installation of a coil is greatly simplified, and an optimal filling between the poles (11) is obtained.

### BACKGROUND OF THE INVENTION

The document EP 730 334 A1 shows a stator for an electrical revolving-armature machine, in the case of which the stator is composed of two parts. Due to this two-part design of the stator, the individual parts cannot be wound. Instead, they must be assembled with premanufactured coils. The advantages of this type of assembly of the stator result essentially for only two poles. Although an exemplary embodiment for a plurality of poles is also provided, they are merely secondary poles, and the desired advantage of better filling of the grooves is no longer obtained when more than two poles are involved.

The documents JP 2000209794 A1 or U.S. Pat. No. 5,859,486 show a stator that is composed of as many segments as there are poles. This results in a large number of parts that must be assembled in an expensive fashion.

Document U.S. Pat. No. 5,552,651 shows a rotor that is composed of two parts. The rotor does not have any windings around the poles, however.

Moreover, stators and rotors are known, in the case of which the fingers are installed individually. Every single finger must be secured, which makes an expensive assembly process necessary. These stators have reduced stability. Furthermore, each coil must be contacted individually, which results in a plurality of contact sites and expensive interconnections with blanking skeletons, for example.

### ADVANTAGES OF THE INVENTION

In contrast, the structural element, according to the invention, for an electrical machine having the characterizing features of claim 1 has the advantage that a structural element for an electrical machine is formed in simple fashion, in the case of which said structural element an optimal filling of the grooves with windings or coil packets is obtained. A smaller size of an electrical machine can therefore be obtained. Additionally, extremely simplified conditions for a winding method result, so that various winding methods such as flyer winding and needle winding, for example, can be used. Additionally, any number of small groove openings is feasible, since the winding wire need not be inserted through the groove opening during winding. Likewise, coils having very thick wires can also be realized.

Advantageous conditions for a winding method result when the poles of the structural element that are directly adjacent to each other in the circumferential direction are not formed by the same carrying body, because a large distance then exists between the poles of an individual carrying body. By producing the winding in two-part (FIGS. 1, 2) or complete (FIG. 3) fashion, the number of wire ends is greatly reduced in comparison with individually applied fingers. This results in a greatly simplified interconnection and contacting technique.

The carrying body is advantageously composed of laminations, because eddy currents are minimized as a result.

The carrying body is advantageously composed of a plastic/magnetic material, because this is easy to manufacture.

A structural element of this type can form a stator or a rotor in advantageous fashion.

### SUMMARY OF THE DRAWINGS

Exemplary embodiments of the invention are shown in simplified form in the drawings and are explained in greater detail in the subsequent description.

FIG. 1a shows a first exemplary embodiment of the structural element according to the invention in a non-assembled state,

FIG. 1b shows it in the partially assembled state, and

FIG. 1c shows it in the assembled state.

FIG. 2a shows a further exemplary embodiment of a structural element according to the invention in the non-assembled state,

FIG. 2b shows it in the partially assembled state, and

FIG. 2c shows it in the assembled state.

FIG. 3a shows a further exemplary embodiment of the structural element according to the invention in the non-assembled state, and

FIG. 3b shows it in the assembled state.

### DESCRIPTION OF THE PREFERRED EMBODIMENTS

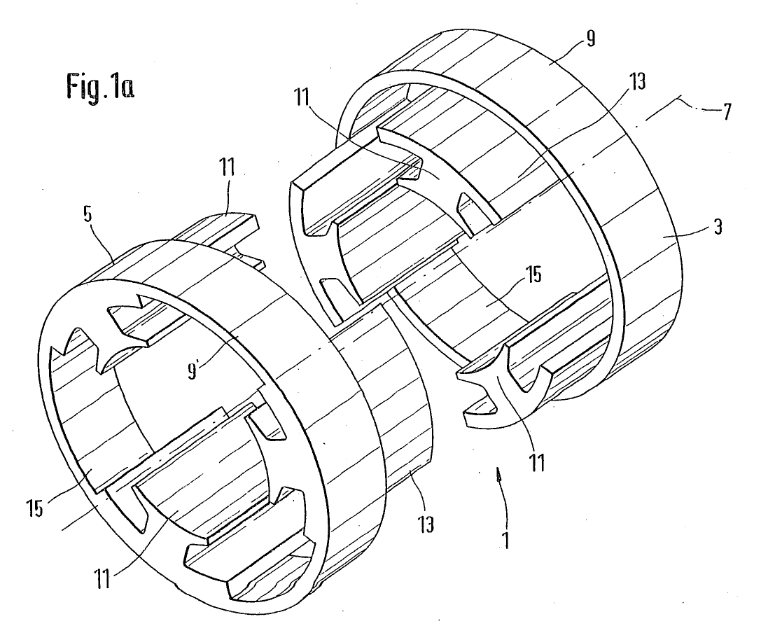

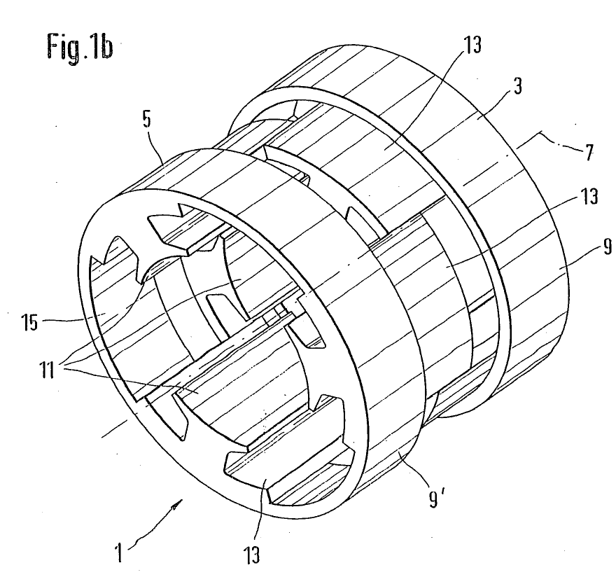

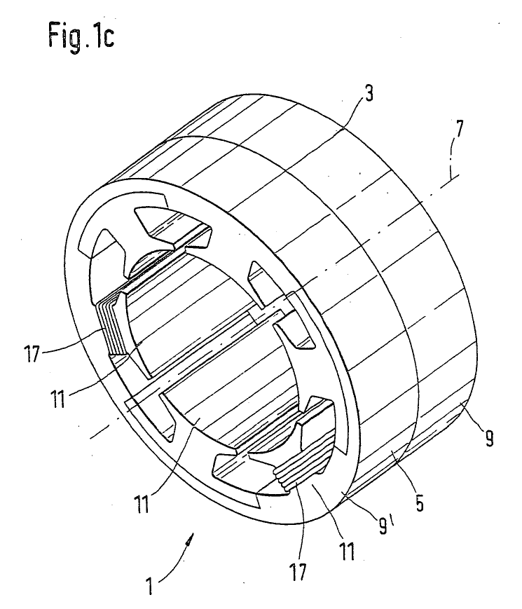

FIG. 1a shows a structural element 1, according to the invention, in the non-assembled state. The structural element 1 is magnetically excitable, e.g., by an electrical coil or a magnet, and it is used for an electrical machine, such as a motor or an alternator, for example.

The structural element 1 is composed, at the least, of a first carrying body 3 and a second carrying body 5. The two carrying bodies 3, 5, are identical, for example, and are joined in the axial direction 7 and are secured to each other. The axial direction 7 forms a center line 7 of the structural element 1, for example.

The carrying body 3, 5 has an outer ring 9, for example, on which at least one pole 11, for example, is developed. The pole 11 is designed integral with the outer ring 9, for example. The pole 11 can also be secured to the ring 9, however, e.g., in that it is pushed on or integrally extruded. In this exemplary embodiment, there are three poles 11 designed in the shape of a dovetail, for example, that are designed integral with the outer ring 9. The pole 11 projects over the ring 9 in an axial direction 7.

To secure the carrying bodies 3, 5, to each other, the pole 11 has a slide-in element 13 on the outer periphery, for example, that is slid into a corresponding recess 15 on the ring 9 of the other carrying body 5, 3. This prevents the carrying bodies 3, 5 from contrarotating in the radial direction. At the same time, the carrying bodies 3 and 5 can also be fastened together in this fashion if, for example, a press fit occurs between the slide-in element 13 and the recess 15.

The carrying bodies 3, 5 can also be fastened together in another manner. The structural element 1 then has six poles 11. The carrying body 3, 5 is composed of laminations or a solid material, for example. The carrying body 3, 5 can also be composed of a mixture of plastic and a magnetic material, in particular a soft-magnetic material, which said mixture is injected, for example. Magnetic material is understood to be magnetizable material and/or magnetized material. The material can be magnetically hard and/or magnetically soft.

One of the carrying bodies 3, 5 can be composed of laminations, and the other can be composed of a mixture of plastic and a magnetic material.

FIG. 1b shows a structural element 1, in the case of which the carrying bodies 3, 5 are slid partially into each other. The slide-in elements 13 of the carrying bodies 3, 5 designed, e.g., in the shape of annular segments, are located directly adjacent to each other in the circumferential direction. The carrying bodies 3, 5 are joined in such a fashion that the poles 11 of the one carrying body 3 extend between the poles 11 of the other carrying body 5.

FIG. 1c shows a structural element 1 in a joined state. In the circumferential direction, each of the poles 11 is formed by another carrying body 3, 5, for example. Likewise, the rings 9 of the carrying bodies 3, 5 and the slide-in elements 13 and the recesses 15 of the carrying bodies 3, 5 are located directly adjacent to each other, so that they more or less form an outer ring 9. Such a structural element 1 is used for a stator of an inner-rotor motor.

In the non-assembled state, as shown in FIG. 1a, a premanufactured coil packet 17 has been arranged around each pole 11, or a winding 17 has been wound around each pole 11. The coils 17 are intentionally not shown in FIGS. 1a and 1b, in order to show how the carrying bodies 3, 5 are constructed and joined. Due to the large distance between the poles 11 of the individual carrying bodies 3, 5 in the non-assembled state, a great deal of space for a winding tool, in particular a needle, is available during the winding procedure, so that the winding procedure is greatly simplified. In the assembled state (FIG. 1c), the space between the poles 11 is filled in optimal fashion, because the coils 17 can be slid together very tightly in the axial direction 7. Sufficient space, i.e., the distance to the next coil 17, must be available during the winding procedure, or the winding needle would get stuck.

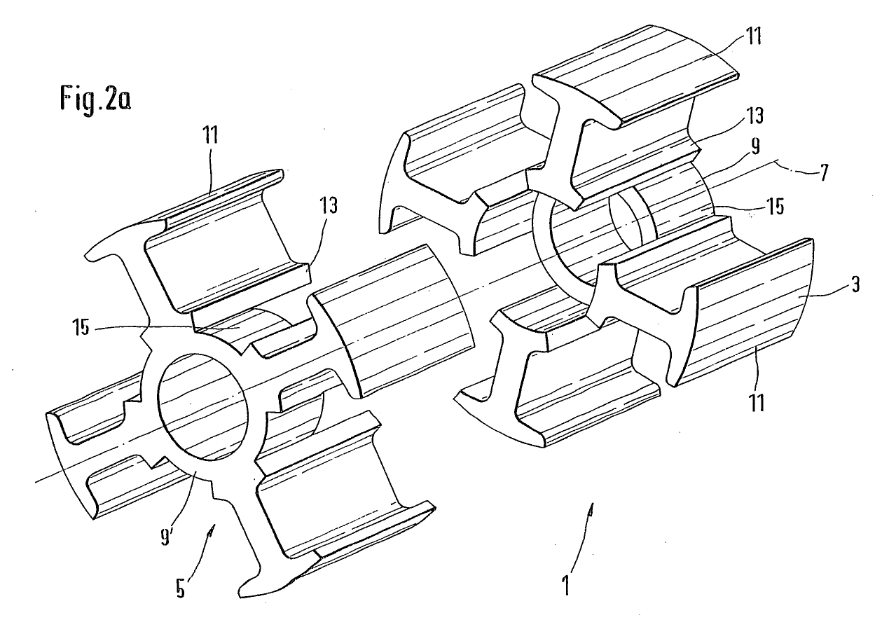

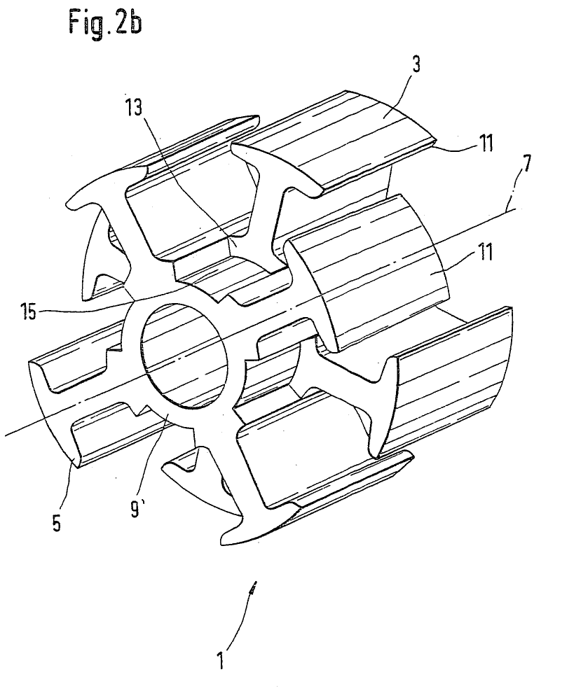

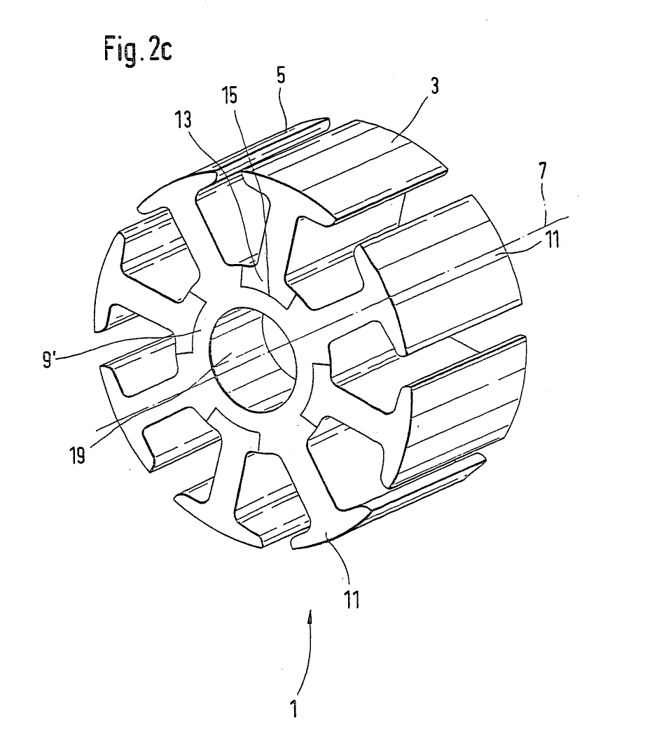

FIG. 2a shows a further exemplary embodiment of a structural element 1 according to the invention. The structural element 1 is also composed, for example, of two carrying bodies 3, 5 that have poles 11 that are located on an inner ring 9 and extend in the radial and axial direction away from the ring 9. The carrying bodies 3, 5 are joined in a fashion similar to that described for FIGS. 1a, 1b and 1c. For this purpose, slide-in elements 13 designed in the shape of annular segments, for example, are developed on the poles 11 on the ends closest to the ring 9, which said slide-in elements form recesses 15 between themselves for the insertion of the slide-in elements 13 of the other carrying body 3, 5. In this case as well, coils 17 have already been wound around the poles 11 designed, e.g., in the shape of a dovetail, which said coils are not shown here, however, to provide greater transparency.

FIG. 2b shows the structural element 1 in the partially assembled state, and FIG. 2c shows it in the assembled state. In the assembled state, the rings 9 of the carrying bodies 3, 5 form a ring 9′ that has an opening 19 into which a rotor shaft, for example, is inserted and secured.

Such a structural element 1 is, for example, a stator for an outer-rotor motor or a rotor for an inner-rotor motor.

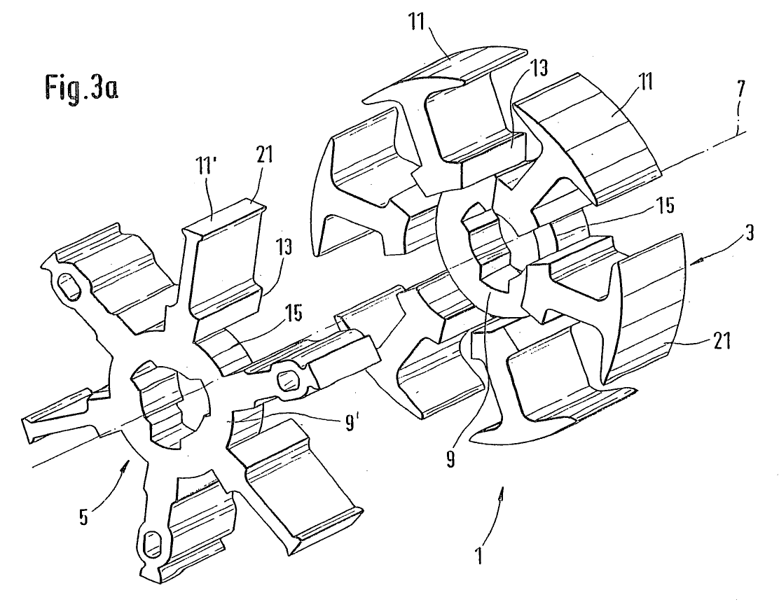

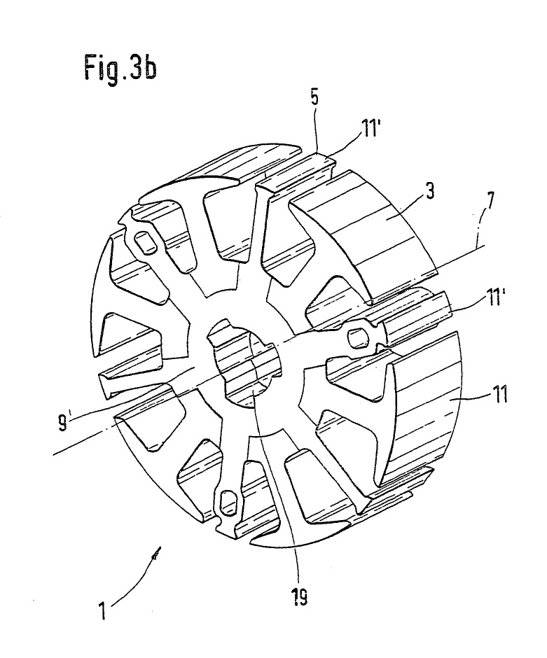

The carrying bodies 3, 5 are shown in FIGS. 3a, 3b in accordance with the descriptions of FIGS. 2a, 2b, 2c. However, one of the carrying bodies 5 only has intermediate poles 11′, which are designed differently than the poles 11 of the other carrying body 3, i.e., the intermediate poles 11′ have a pole head 21 that is narrower in the circumferential direction than the poles 11. A coil 17 is not located around the intermediate poles 11′, nor is a winding wound around said intermediate poles. The “intermediate poles” 11′ serve only to guide magnetic flux.

The winding can be placed on the carrying body 3 in entirety without interruption. Slide-in elements 13 and recesses 15 used for assembly are provided on the intermediate poles 11′ and poles 11 on the ends closest to the rings 9.

What is claimed is:

1. A structural element for an electrical machine that is magnetically excitable, comprising at least one carrying body,
wherein at least two carrying bodies (3, 5) joined in the axial direction (7) form the structural element (1).

2. The structural element according to claim 1,
wherein at least one of the carrying bodies (3, 5) has at least one pole (11), and wherein at least one coil (17) is arranged around the pole (11).

3. The structural element according to claim 1 or 2,
wherein at least one of the carrying bodies (3, 5) has poles (11), and wherein the poles (11) of the structural element (1) that are directly adjacent to each other in the circumferential direction are not formed by the same carrying body (3, 5).

4. The structural element according to claim 1, 2 or 3,
wherein the carrying body (3, 5) is composed of laminations.

5. The structural element according to claim 2 or 3,
wherein the poles (11) are at least partially interconnected with a ring (9) of the carrying body (3, 5).

6. The structural element according to claim 1 or 3,
wherein the structural element (1) forms a stator.

7. The structural element according to claim 1 or 3,
wherein the structural element (1) forms a rotor.

8. The structural element according to claim 2, 3, or 4,
wherein at least one of the carrying bodies (3, 5) has at least one slide-in element (13) and at least one of the carrying bodies (3, 5) has at least one recess (15) for the slide-in element (13), and
wherein the carrying bodies (3, 5) are interconnected by means of the at least one slide-in element (13) and the at least one recess (15) in such a fashion that they do not rotate in opposite directions.

9. The structural element according to one of the preceding claims,
wherein one of the carrying bodies (3, 5) has poles (11) with coils (17), and the other carrying body (3, 5) is equipped with intermediate poles (11′) around which no coils are arranged and that are located between the poles (11) in the circumferential direction once the carrying bodies (3, 5) are joined.

10. The structural element according to claim 1, 2, 3 or 4,
wherein the carrying body (3, 5) is composed of a mixture of a plastic and a magnetic material.

11. A structural element for an electrical machine that is magnetically excitable, comprising at least one carrying body,
wherein at least two carrying bodies (3, 5) joined in the axial direction (7) form the structural element (1).

12. The structural element according to claim 11,
wherein at least one of the carrying bodies (3, 5) has at least one pole (11), and wherein at least one coil (17) is arranged around the pole (11).

13. The structural element according to claim 11,
wherein at least one of the carrying bodies (3, 5) has poles (11), and wherein the poles (11) of the structural element (1) that are directly adjacent to each other in the circumferential direction are not formed by the same carrying body (3, 5).

14. The structural element according to claim 11,
wherein the carrying body (3, 5) is composed of laminations.

15. The structural element according to claim 12,
wherein the poles (11) are at least partially interconnected with a ring (9) of the carrying body (3, 5).

16. The structural element according to claim 11,
wherein the structural element (1) forms a stator.

17. The structural element according to claim 11,
wherein the structural element (1) forms a rotor.

18. The structural element according to claim 12,
wherein at least one of the carrying bodies (3, 5) has at least one slide-in element (13) and at least one of the carrying bodies (3, 5) has at least one recess (15) for the slide-in element (13), and
wherein the carrying bodies (3, 5) are interconnected by means of the at least one slide-in element (13) and the at least one recess (15) in such a fashion that they do not rotate in opposite directions.

19. The structural element according to claim 11,
wherein one of the carrying bodies (3, 5) has poles (11) with coils (17), and the other carrying body (3, 5) is equipped with intermediate poles (11′) around which no coils are arranged and that are located between the poles (11) in the circumferential direction once the carrying bodies (3, 5) are joined.

20. The structural element according to claim 11,
wherein the carrying body (3, 5) is composed of a mixture of a plastic and a magnetic material.
